(19) United States
(12) Patent Application Publication
(10) Pub. No.: US 2017/0060674 A1
(43) Pub. Date: Mar. 2, 2017

(54) PERSISTENT CHECKSUM DATA VALIDATION

(71) Applicant: Hewlett-Packard Development Company, L.P., Houston, TX (US)

(72) Inventors: Siamak Nazari, Mountain View, CA (US); Tim Silversides, Belfast (GB)

(21) Appl. No.: 14/843,824

(22) Filed: Sep. 2, 2015

(51) Int. Cl. G06F 11/10; H04L 1/08

(52) U.S. Cl. CPC G06F 11/1004; H04L 1/08

(57) ABSTRACT

Examples relate to persistent checksum data validation. In some examples, it is determined if a storage array supports a persistent checksum capability. After determining that the storage array supports the persistent checksum capability, protection information is added to a data packet at an egress port, where the protection information includes a cyclic redundancy check (CRC), a serial number, and an offset. The data packet is sent with the protection information to the storage array, where the storage array uses the protection information to validate the data packet. A data response is received from the storage array, and then the protection information is used to validate the data response.

### BACKGROUND

A storage area network (SAN) is a dedicated special-purpose network that interconnects different kinds of storage devices (e.g., storage, switches with associated data servers, etc.) to provide access to consolidated, block level data storage to various applications.

### BRIEF DESCRIPTION OF THE DRAWINGS

The following detailed description references the drawings, wherein:

FIG. 1 is a block diagram of an example computing device for persistent checksum data validation;

FIG. 2 is a block diagram of an example system showing host device communication with a storage array to provide persistent checksum data validation;

FIG. 3 is a flowchart of an example method for execution by a computing device for persistent checksum data validation; and

FIG. 4 is a flowchart of an example method for execution by a host device for validating a data response from a storage array using a persistent checksum.

### DETAILED DESCRIPTION

Many SAN transport protocols support the use of a cyclic redundancy check (CRC) or other checksum to detect corruption of data in transmission. Corrupt frames can be discarded, and re-transmission of the relevant data can be initiated by a higher layer of the protocol stack in use. Data corruption in block storage systems can occur. Such corruption may be introduced, for example, by faulty hardware or software components. Data corruption can be detected by the host application when reading and processing the corrupted data, which may be too late for non-disruptive data recovery and may result in application downtime, data loss and disruptive and time-consuming recovery from a backup.

In examples described herein, a persistent checksum solution is used that allows data corruption to be detected on transmission of block data, which permits early error detection, recovery, and avoidance of data loss. In some cases, the examples use a protection information format (e.g., T10 small computer system interface (SCSI) protection information format) that allows for existing hardware support for tag generation and validation to be leveraged for performance benefits. The protection information format may define a CRC (i.e., guard tag) and a reference tag, which may be the least significant bits of a logical block address and may be associated with each data block. Some examples described herein use a 512-byte block size; however, the approach is applicable across a range of block sizes.

In some examples, a host device is attached via host bus adapter (HBA) to a storage array that supports the persistent checksum capability, where a suitable HBA device driver with persistent checksum support is installed on the host operating system (OS). When initiating a data transmission, the HBA device driver can be used to perform a handshake with the target storage array to determine if the storage array supports the persistent checksum. If the storage array does support the persistent checksum, the host device can add protection information to the data packet at an egress port of the host device, which allows for data transmissions to be validated during the back and forth communications between the host device and storage array.

Examples disclosed herein provide persistent checksum data validation. In some examples, it is determined if a storage array supports a persistent checksum capability. After determining that the storage array supports the persistent checksum capability, protection information is added to a data packet at an egress port, where the protection information includes a cyclic redundancy check (CRC), a serial number, and an offset. The data packet is sent with the protection information to the storage array, where the storage array uses the protection information to validate the data packet. A data response is received from the storage array, and then the protection information is used to validate the data response.

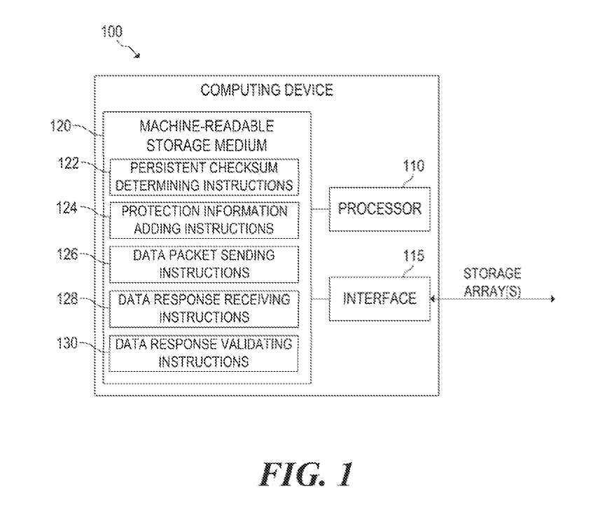

Referring now to the drawings, FIG. 1 is a block diagram of an example computing device 100 for persistent checksum data validation. The example computing device 100 may be a server, a desktop computer, a laptop, or any other electronic device suitable for validating data using a persistent checksum. In the example of FIG. 1, computing device 100 includes processor 110, interface 115, and machine-readable storage medium 120.

Processor 110 may be one or more central processing units (CPUs), microprocessors, and/or other hardware devices suitable for retrieval and execution of instructions stored in machine-readable storage medium 120. Processor 110 may fetch, decode, and execute instructions 122, 124, 126, 128, 130 to enable persistent checksum data validation, as described below. As an alternative or in addition to retrieving and executing instructions, processor 110 may include one or more electronic circuits comprising a number of electronic components for performing the functionality of one or more of instructions 122, 124, 126, 128, 130.

Interface 115 may include a number of electronic components for communicating with end devices. For example, interface 115 may be wireless interfaces such as wireless local area network (WLAN) interfaces and/or physical interfaces such as Ethernet interfaces, Universal Serial Bus (USB) interfaces, external Serial Advanced Technology Attachment (eSATA) interfaces, or any other physical connection interface suitable for communication with end devices. In operation, as detailed below, interface 115 may be used to send and receive data to and from storage arrays.

Machine-readable storage medium 120 may be any electronic, magnetic, optical, or other physical storage device that stores executable instructions. Thus, machine-readable storage medium 120 may be, for example, Random Access Memory (RAM), Content Addressable Memory (CAM), Ternary Content Addressable Memory (TCAM), an Electrically-Erasable Programmable Read-Only Memory (EEPROM), flash memory, a storage drive, an optical disc, and the like. As described in detail below, machine-readable storage medium 120 may be encoded with executable instructions for enabling persistent checksum data validation.

Persistent checksum determining instructions 122 determine if a storage array supports a persistent checksum capability. Persistent checksum allows for data to be validated as it travels from a host device to a storage array and then back to the host device. In other words, persistent checksum is persistent because it allows for the protection information to be initiated at the host device and then used to validate the data at the storage array, any intervening device, and finally back at the host. After it is determined that the storage array supports the persistent checksum capability, data packets sent to the storage array can be created with protection information. The determination that the persistent checksum capability is supported can be performed once while the host device initiates its connection with the storage array.

Protection information adding instructions 124 adds protection information to data packets at an egress port of host device 100. Protection information can include a CRC for verifying that the data packets is not modified, a serial number for verifying a source of the data packet, and an offset for determining where to start reading the data packet. For example if data-out SCSI block commands (i.e., commands where block data transfer from initiator to target takes place) are used, the protection information adding instructions 124 can ensure that protection information is inserted into the write data on data transfer to the storage array and can indicate in a SCSI Command Descriptor Block that such protection information is included. The storage array, in turn, can validate the protection information and return an invalid SCSI status to the host in the event that this validation fails.

Data packet sending instructions 126 sends the data packet to the storage array. The data packet is transmitted with the protection information so that the storage can validate the data package upon receipt. As described above, the data packet can be relayed through intermediary devices (e.g., routers, switches, etc.), which in some cases can use the protection information to validate the data packet as well. Where the storage array detects data integrity errors, the storage array can report such errors using SCSI status and sense data, which are not specific to data integrity fields. The SCSI data can be mapped to OS specific command completion statuses by the hosting device 100.

Data response receiving instructions 128 receives a data response from the storage array. For example, the data response may be stored data that was requested in the data packet. The data response includes the protection information that was previously included in the data packet.

Data response validating instructions 130 uses the protection information to validate the data response. For example, in the event of any validation failure, an SCSI command can be completed by the data response validating instructions 130 with an error status. Where the host HBA detects data integrity errors, the host HBA device driver can return an OS-specific command completion status when completing the command.

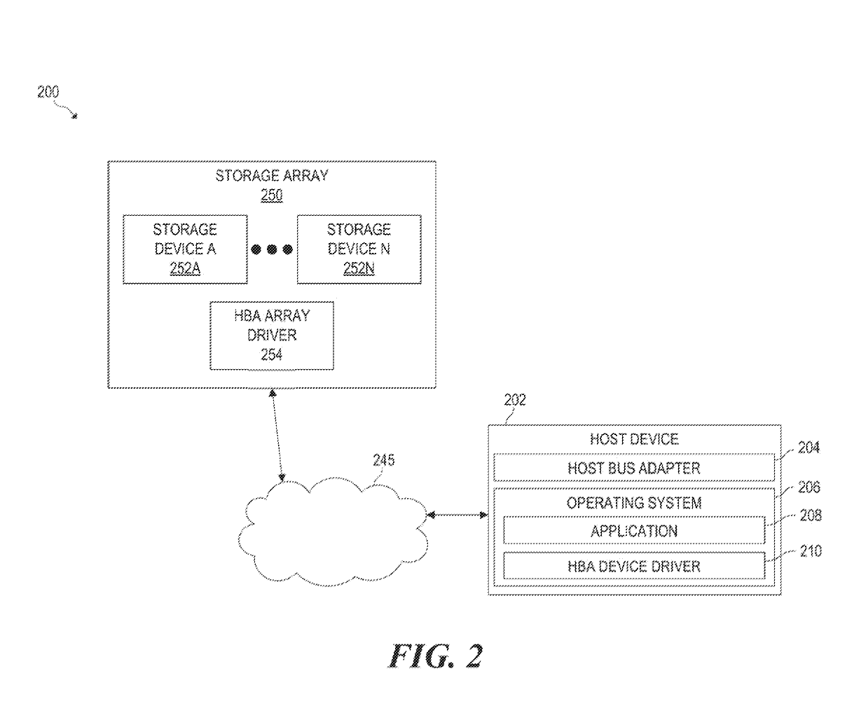

FIG. 2 is a block diagram of an example system 200 including host device 202 interacting with storage array 250 to provide persistent checksum data validation. The components of host device 202 may be similar to the corresponding components of computing device 100 described with respect to FIG. 1.

As illustrated, host device 202 includes host bus adapter 204 and operating system 206. Host bus adapter 204 provides input/output processing and connects the host device 202 to the storage array 250. Host device 202 can control host bus adapter 204 using HBA device driver 210. Host bus adapter 204 may include ingress and egress ports (not shown) for communicating with other computing devices.

Operating system 206 manages hardware such as the host bus adapter 204 and provides common functionality for applications 208. Operating system 206 can use drivers such as HBA device driver 210 to control the host bus adapter 204. In this example, applications 208 may make data requests that are sent as data packets to storage array 250 via the host bus adapter 204. The HBA device driver 210 is used by the operating system 206 to send the data packets with the host bus adapter 204.

The HBA device driver 210 can be specialized to perform functionality related to the transmission of the data packets. Specifically, the HBA device driver 210 can be modified to support a persistent checksum capability. For example, the HBA device driver 210 can be configured to discover whether the storage array 250 also supports the persistent checksum capability when initializing a connection with the storage array 250 (i.e., HBA device driver 210 performs a handshake to discover capabilities of the storage array 250).

Storage array 250 can include various storage devices 252A, 252N such as magnetic hard drives, solid state drives, high capacity random access memory, etc. Storage array 250 can also include HBA array driver 254 for communicating with host device 202. HBA array driver 254 supports the persistent checksum capability and can process protection information inserted into in data packets by host device 202. Specifically, HBA array driver 254 allows storage array 250 to validate data packets received from host device 202.

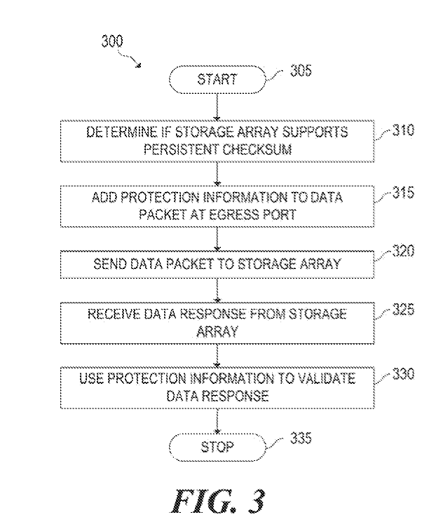

FIG. 3 is a flowchart of an example method 300 for execution by a computing device 100 for persistent checksum data validation. Although execution of method 300 is described below with reference to computing device 100 of FIG. 1, other suitable devices for execution of method 300 may be used such as host device 202 of FIG. 2. Method 300 may be implemented in the form of executable instructions stored on a machine-readable storage medium, such as computer readable medium 120 of FIG. 1, and/or in the form of electronic circuitry.

Method 300 may start in block 305 and continue to block 310, where computing device 100 determines if a storage array supports a persistent checksum capability. Persistent checksum allows for data packets from the computing device 100 to be validated by the storage array and vice versa. In block 315, computing device 100 inserts protection information to data packets at an egress port of host device 100. Protection information can include a CRC for verifying that the data packets is not modified, a serial number for verifying a source of the data packet, and an offset for determining where to start reading the data packet.

In block 320, computing device 100 sends the data packet with the protection information to the storage array. In block 325, computing device 100 receives a data response that includes the protection information from the storage array. In block 330, computing device 100 uses the protection information to validate the data response. If there is a data integrity error, the computing device 100 can return an OS-specific command completion status when completing the command. Method 300 may then continue block 335, where method 300 may stop.

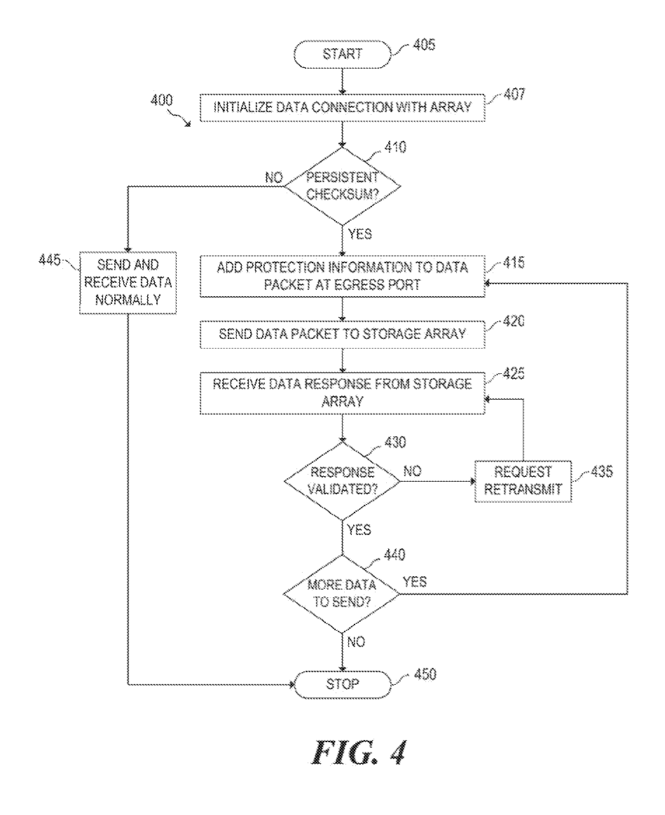

FIG. 4 is a flowchart of an example method 400 for execution by a host device 202 for validating a data response from a storage array using a persistent checksum. Although execution of method 400 is described below with reference to host device 202 of FIG. 2, other suitable devices for execution of method 400 may be used. Method 400 may be implemented in the form of executable instructions stored on a machine-readable storage medium and/or in the form of electronic circuitry.

Method 400 may start in block 405 and continue to block 407, where host device 202 initializes a data connection with a storage array. Specifically, host device 202 can perform a handshake with the storage array, and an egress port of host device 202 can be assigned to send messages to the storage array. In block 410, host device 202 determines if the storage array supports a persistent checksum capability. If the storage array does not support the persistent checksum capability, host device 202 send data to and receives data from the storage array normally (i.e., without protection information) in block 445.

If the storage array does support the persistent checksum capability, host device 202 inserts protection information to data packets at an egress port of host device 100 in block 415. Protection information can include a CRC for verifying that the data packets is not modified, a serial number for verifying a source of the data packet, and an offset for determining where to start reading the data packet. In block 420, host device 202 sends the data packet with the protection information to the storage array. In block 425, host device 202 receives a data response that includes the protection information from the storage array.

In block 430, host device 202 determines if the data response is valid. If the data response is invalid, host device 202 can request the storage array to retransmit the data response in block 435. If the data response is valid, host device 202 can process the data response and then determine if there is more data to send in block 440. If there is more data to send, method 400 can return to block 415 to process further data packets. If there is no more data to send, method 400 may continue to block 445, where method 400 may stop.

In some examples, the foregoing disclosure describes a number of examples for enabling persistent checksum data validation. In this manner, the examples disclosed herein may facilitate data validation by confirming the storage array supports a persistent checksum capability and then inserting protection information in data packets at the host device as they are sent to the storage array.

We claim:

1. A computing device comprising:
a host bus adapter comprising an egress port to communicate with a storage array; and
a processor to:
determine if the storage array supports a persistent checksum capability;
after determining that the storage array supports the persistent checksum capability, add protection information to a data packet at the egress port, wherein the protection information comprises a cyclic redundancy check (CRC), a serial number, and an offset;
send the data packet with the protection information to the storage array, wherein the storage array uses the protection information to validate the data packet;
receive a data response from the storage array; and
use the protection information to validate the data response.

2. The computing device of claim 1, wherein the processor is further to:
after determining that a second storage array does not support the persistent checksum capability, send a second data packet without the protection information to the second storage array.

3. The computing device of claim 1, wherein validating the data response comprises using the CRC to verify that the data response has not been modified, using the serial number to verify the origin of the data response, and using the offset to determine a data start location in the data response.

4. The computing device of claim 1, wherein the processor is further to, in response to determining that the data response is invalid, send a retransmit request to the storage array.

5. The computing device of claim 1, wherein the data packet includes a low level CRC that can be used to detect data corruption.

6. The computing device of claim 1, wherein the protection information uses a T10 small computer system interface (SCSI) format.

7. A method for persistent checksum data validation, the method comprising:
initiating a data connection with a storage array;
after determining that the storage array supports the persistent checksum capability, inserting protection information to a data packet that includes a low level CRC as the data packet is sent from an egress port to the storage array, wherein the protection information comprises a cyclic redundancy check (CRC), a serial number, and an offset, and wherein the storage array uses the protection information to validate the data packet;
receiving a data response from the storage array; and
using the protection information to validate the data response.

8. The method of claim 7, further comprising:
initiating a second data connection with a second storage array; and
after determining that the second storage array does not support the persistent checksum capability, sending a second data packet without the protection information to the second storage array.

9. The method of claim 7, wherein validating the data response comprises using the CRC to verify that the data response has not been modified, using the serial number to verify the origin of the data response, and using the offset to determine a data start location in the data response.

10. The method of claim 7, further comprising, in response to determining that the data response is invalid, sending a retransmit request to the storage array.

11. The method of claim 7, wherein the protection information uses a T10 small computer system interface (SCSI) format.

12. A non-transitory machine-readable storage medium encoded with instructions executable by a processor, the machine-readable storage medium comprising instructions to:
initiate a data connection with a storage array;
after determining that the storage array supports the persistent checksum capability, insert protection information to a data packet that includes a low level CRC at an egress port, wherein the protection information comprises a cyclic redundancy check (CRC), a serial number, and an offset;
send the data packet with the protection information to the storage array, wherein the storage array uses the protection information to validate the data packet;
receive a data response from the storage array; and
use the CRC to verify that the data response has not been modified, the serial number to verify the origin of the data response, and the offset to determine a data start location in the data response.

13. The non-transitory machine-readable storage medium of claim 12, wherein the instructions are further to:
initiate a second data connection with a second storage array; and
after determining that the second storage array does not support the persistent checksum capability, send a second data packet without the protection information to the second storage array.

14. The non-transitory machine-readable storage medium of claim 12, wherein the instructions are further to, in response to determining that the data response is invalid, send a retransmit request to the storage array.

15. The non-transitory machine-readable storage medium of claim 12, wherein the protection information uses a T10 small computer system interface (SCSI) format.
